(19) United States
(12) Patent Application Publication
(10) Pub. No.: US 2017/0201805 A1
(43) Pub. Date: Jul. 13, 2017

(54) Adapting a Video Compression for a Mobile Server

(71) Applicant: Bayerische Motoren Werke Aktiengesellschaft, Muenchen (DE)

(72) Inventors: Damien Schroeder, Muenchen (DE); Christian Lottermann, Muenchen (DE); Eckehard Steinbach, Olching (DE)

(21) Appl. No.: 15/471,673

(22) Filed: Mar. 28, 2017

Related U.S. Application Data
(63) Continuation of application No. PCT/EP2015/069103, filed on Aug. 20, 2015.

(30) Foreign Application Priority Data
Sep. 24, 2014 (DE) 10 2014 219 686.8

(51) Int. Cl. H04N 21/6373; H04N 21/414; H04N 21/61; H04N 21/24; H04N 21/2343; H04N 21/235

(52) U.S. Cl. CPC H04N 21/6373; H04N 21/234381; H04N 21/2353; H04N 21/6131; H04N 21/23439; H04N 21/2402; H04N 21/41422

(57) ABSTRACT

The invention relates to a method and a compression device for compressing a data stream from a source to at least one sink in which at least one first bandwidth and one second bandwidth of a network, which is available to the source for transmitting the data stream to the at least one sink, is determined. The data stream may be is compressed to a first compressed data stream using at least one first compression rate, and to a second compressed data stream using a second compression rate. The first compression rate may be optimized for transmission using the first bandwidth, while the second compression rate may be optimized for transmission using the second bandwidth. The first compressed data stream and the second compressed data stream may then be providing for transmission at the same time.

### CROSS REFERENCE TO RELATED APPLICATIONS

This application is a continuation of PCT International Application No. PCT/EP2015/069103, filed Aug. 20, 2015, which claims priority under 35 U.S.C. §119 from German Patent Application No. 10 2014 219 686.8, filed Sep. 29, 2014, the entire disclosures of which are herein expressly incorporated by reference.

### BACKGROUND AND SUMMARY OF THE INVENTION

The invention relates to adapting a video compression for a mobile server. The invention relates particularly to an application in which a video data stream needs to be transmitted from a source via a network connection, for example via the Internet and/or a wireless connection, to at least one receiver.

Adaptive HTTP streaming systems (AHS) are known that provide for adaptive adjustment of live and deferred (on demand) video streams between a source and at least one receiver. Dynamic adaptive streaming over HTTP (DASH), also known as MPEG-DASH, has seen the introduction, since November 2011, of a standard for AHS. This involves N video levels of the same video being produced in parallel at the source end using different bit rates and being divided into segments of a predefined length, for example 2 seconds. The video levels are of a nature such that a high bit rate results in a good level of subjective user satisfaction (quality of experience, QoE), whereas a low bit rate results in a poor level of user satisfaction. These segments of different bit rates are referenced within an index file (MPD) and made available to the receivers via a web server. An algorithm at the receiver end continuously measures the network throughput between the source and the receiver and the buffer fill level and dynamically requests a video level suited to the network performance using standard HTTP requests. The segments are then transmitted from a web server at the source to at least one receiver using HTTP transport mechanisms.

AHS systems are used primarily in what are known as content delivery networks (CDNs), which provide for transmission of a video stream to multiple receivers of different nature with different network links. In the case of such systems, it is assumed that the server on which the video levels are stored has a stable and wideband network link. The advantage of AHS systems is particularly the opportunity for dynamic matching of the video stream to the different circumstances of the receivers. The N different bit rates of the video levels are stipulated before the AHS system is implemented. In the case of present implementations, N is in the range from 10 to 15 video levels, depending on the capacity of the AHS coding device.

Currently known implementations of AHS are Smooth Streaming from Microsoft, MPEG-DASH, HTTP Live Streaming from Apple or HTTP Dynamic Streaming (HDS) from Adobe, for example.

As a result of the stipulation of the bit rates of the AHS video levels at the implementation stage, a static preliminary selection is made that needs to cover a wide range of potential transmission speeds to the receivers.

The intention is in the future to use AHS systems for live streaming from camera systems from mobile terminals to a remote unit that provide for a link via cellular mobile radio systems, for example smartphones or vehicles. In this context, the mobile terminal is the source, which, in contrast to content delivery networks, has no stable wideband network link. Therefore, the potential network performance range is firstly obtained by virtue of the capacity of the usable mobile radio systems of the mobile terminal. Secondly, the limited capacity of the mobile terminals means that the number of video levels produced is limited and is below the number customary for content delivery networks, for example lower than 5. As a result of the performance fluctuations and the different capacity of the different radio access systems, a situation can arise in which the static stipulation of the video levels means that only a small subset of the video levels is usable for the present network performance level. Conversely, this can result in the subjective user quality being at a constant less-than-optimum level. Since the video levels have to cover the entire performance range of a network, the differences in the quality of the videos from one video level to the next are relatively great.

In the case of a content delivery network that serves multiple receivers at the same time, a situation can arise in which receivers of a similar nature and/or network links of a similar nature for receivers mean that only some of the previously defined video levels are used. In live systems, this results in some of the video levels not being used.

US 2006/0294210 A1 discloses ad-hoc services on a mobile phone.

Both of the aforementioned causes result in firstly video levels being produced unused and secondly user satisfaction being less than optimum.

An object of the invention is to provide an improved method and an improved apparatus for compressing a data stream.

The method according to the invention for compressing a data stream from a source to at least one sink comprises the step of ascertainment, during transmission of the data stream, of at least a first bandwidth and a second bandwidth of a network that are available to the source for transmitting the data stream to at least one sink. The data stream is compressed at least using a first compression rate to produce a first compressed data stream and using a second compression rate to produce a second compressed data stream, the first compression rate being chosen such that it is optimized for a transmission using the first bandwidth, and the second compression rate being chosen such that it is optimized for a transmission using the second bandwidth. The first and second compressed data streams may be provided for transmission at the same time.

The source may be a mobile device and the network may be a mobile radio network. The bandwidth and/or the mobile radio technology, i.e. the network protocol, of the mobile radio network can vary on the basis of the location. The source may be connected to a plurality of mobile radio networks. The source can use a plurality of physical uplink connections to transmit at least one compressed data stream at the same time.

The method according to the invention selects the compression rates dynamically at runtime. The effect that can be achieved by this is that only a small number of compressed data streams have to be produced at the same time. This puts less load on the resources of the mobile device. The method according to the invention is particularly suitable for streaming based on the HTTP protocol. The streaming may be pull-based streaming. The compressed data streams can be transmitted on a packet-oriented basis, for example using the Internet protocol (TCP/IP).

The method can provide a plurality of compressed data streams each having a different compression rate. In one embodiment, preferably approximately 4 to 5 compressed data streams are provided at the same time.

A mobile radio network can couple a mobile device using different technologies that have a different bandwidth. The mobile radio technology may be GSM, UMTS, LTE, WLAN or the like, for example. Each mobile radio technology has a different bandwidth. According to the invention, it is ascertained what bandwidths the network can provide. In one embodiment, the data stream is compressed in up to four different bandwidths. The sink, i.e. the receiver, can retrieve the data stream in the bandwidth that is suitable for the receiver. As soon as the source changes its location and a particular mobile radio technology is no longer available, the source is no longer able to provide the data stream using the corresponding bandwidth of this mobile radio technology. If a change of location means that an additional mobile radio technology, for example with a higher bandwidth, is available, then the source can also provide the data stream using a bandwidth that corresponds to the additionally available mobile radio technology. A mobile radio technology within the context of this invention may be a network protocol, for example GSM, UMTS, LTE, WLAN, IEEE 802.11. For this aspect of the invention, the compression rates are selected essentially on the basis of the bandwidths of the respective mobile radio technologies.

In the first embodiment, the difference between the first bandwidth and the second bandwidth is essentially as great as the difference between a mobile radio technology and a mobile radio technology with the next highest or next lowest bandwidth. In a further embodiment, the difference between the first bandwidth and the second bandwidth may be less than the difference in a transmission rate of a mobile radio technology from the transmission rate of the mobile radio technology with the next highest or next lowest transmission rate. This allows finer gradation of the bandwidth requirement and of the compression rate of the video data stream to be attained. Consequently, the data stream can be used by two mobile radio technologies, which means that no abrupt changes in the video quality occur during a transfer from one network cell to another network cell and when changing mobile radio technology. Further, buffer underrun is avoided.

The step of ascertainment of the first bandwidth and the second bandwidth can advantageously comprise: ascertainment of statistical data pertaining to data streams requested from the source. The step of ascertainment of the first bandwidth and the second bandwidth can comprise ascertainment of the bandwidth from the source to the network and/or ascertainment of the bandwidth from the network to at least one sink. By way of example, the present bandwidth from the source to the network and/or the present bandwidth from the network to the sink can be measured. In another embodiment, the probable bandwidth from the source to the network and/or from the network to the sink can be ascertained by means of historic data. Further, the bandwidth from the network to at least one sink can be ascertained by means of statistical data. In another embodiment, the distribution of the bandwidth from the network to a plurality of sinks can be ascertained on the basis of access to the compressed data streams in a present period. The distribution can comprise what compression rates are used by the plurality of sinks to request the compressed data streams. The method can provide the bandwidths that, from a statistical point of view, are requested most frequently by a plurality of sinks. The statistical data can comprise what compression rates are used by the plurality of sinks to request the compressed data streams. Ascertainment of the bandwidth from a source to the network and/or from a network to a sink can comprise requesting a piece of information about possible bandwidths from the network. The first and second compression rates can be ascertained on the basis of the behavior of the plurality of sinks. The behavior can comprise the compression rate requested by at least one sink. As a result of determination of the first compression rate and the second compression rate by means of the statistical data and/or the distribution of the access to the compressed data streams, it is possible to ascertain the compression rates on the basis of the behavior of the sinks. In another embodiment, the behavior of the sinks can comprise the user behavior of at least one sink.

It is possible for at least one property of an application of a sink to be ascertained. A property of the sink may be the screen resolution and/or the resolution of a video reproduction device, for example. The first compression rate and/or the second compression rate can be ascertained on the basis of the property of the application of the sink.

The method can compress the data stream using a third compression rate, for which at least one parameter is modified in comparison with the first compression rate, the difference between the third compression rate and the first compression rate being less than or equal to the difference between the third compression rate and the second compression rate. As a result, it is possible for a compression rate to be provided that is close to the first compression rate. This step may be useful if a large number of sinks retrieve the data stream using the first bandwidth. As a result, the data stream can be provided using a higher bandwidth, which has a positive effect on the level of user satisfaction (QoE). The data stream can be provided using more finely granular gradation of the compression rate. As a result, the sinks have more opportunities to select a compression rate and/or a bandwidth that results in the best possible level of user satisfaction (QoE). The method can terminate the compression of the data stream using the second compression rate, for example if the data stream is not retrieved by a terminal using the second bandwidth. In this embodiment, the first compression rate is used for a transmission of the data stream using a first network technology. The second compression rate is used for a transmission of the data stream using a second network technology, the second network technology having the next lowest or next highest bandwidth in comparison with the first network technology. The first and second compression rates can be selected on the basis of the compressed data streams retrieved by the sinks. The third compression rate may be the mean value between the first and second compression rates.

The data stream and/or the compressed data streams can have video data. The compression rate can comprise the frame rate, the image quality and/or the resolution of the video data. The property of the aforementioned application of the sink may be the resolution of the video data. The third compression rate can have the same resolution as the first compression rate. The third compression rate can have a different frame rate than the first compression rate. As a result, the video data stream can be displayed better on the sink, because fewer motion artefacts arise. The data streams can also comprise metadata.

The method can advantageously be used for transmitting a video stream from a mobile terminal to a remote sink. In this case, the compression rate may be what is known as a video level. Such levels are defined in H.264, for example. A video level can determine the resolution, the bit rate, the image quality and the frame rate, for example. The method according to the invention can select a dynamic matching for the compression rate, for example the bit rate, by virtue of a predetermined number of video levels. The compression rates, for example the bit rates, of the video levels are, in one embodiment, chosen such that they are in the range of the network performance level of the present connection of the source.

The object of the invention is also achieved by a compression apparatus that is designed to comprise a data stream. The compression apparatus comprises an ascertainment device that is designed to ascertain at least a first bandwidth and a second bandwidth of a network that are available to the source for transmitting the data stream to at least one sink. The compression apparatus also comprises a compression device that is designed to compress the data stream using at least a first compression rate to produce a first compressed data stream and using a second compression rate to produce a second compressed data stream, the first compression rate being chosen such that it is optimized for a transmission using the first bandwidth, and the second optimization rate being chosen such that it is optimized for a transmission using the second bandwidth. The source may be a mobile device that provides the first compressed data stream and the second compressed data stream for transmission at the same time, and the network may be a mobile radio network. The bandwidth and/or the mobile radio technology, for example the network protocol, of the mobile radio network can vary on the basis of the location.

The ascertainment device can ascertain the bandwidth from the source to the network, can ascertain the bandwidth from the network to at least one sink, can ascertain the present bandwidth from the source to the network, can ascertain the present bandwidth from the network to at least one sink, can ascertain the probable bandwidth from the source to the network by means of historic data, can ascertain the probable bandwidth from the network to at least one sink by means of historic data, can ascertain the bandwidth from the network to at least one sink by means of statistical data, can ascertain the distribution of the bandwidth from the network to a plurality of sinks on the basis of access to the compressed data streams in a present period and can retrieve a piece of information about available bandwidths from the network. The first and second compression rates can be ascertained on the basis of the behavior of the plurality of sinks. The statistical data can comprise what compression rates are used by the plurality of sinks to request the compressed data streams. The distribution can comprise what compression rates are used by the plurality of sinks to request the compressed data streams.

The invention also relates to a video compression apparatus that has the aforementioned compression apparatus, wherein the data stream and/or the compressed data streams have video data and the compression rate comprises the frame rate, the image quality and/or the resolution.

The compression apparatus and the video compression apparatus may be developed as has been described above for the method.

The invention also relates to a computer program product that, when executed on a computer having a processor and a memory, carries out the method described above.

The invention is now described in more detail with reference to the appended figures, which show nonrestrictive embodiments of the invention and in which:

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows an exemplary streaming architecture;

FIG. 2 shows exemplary AHS/DASH video levels;

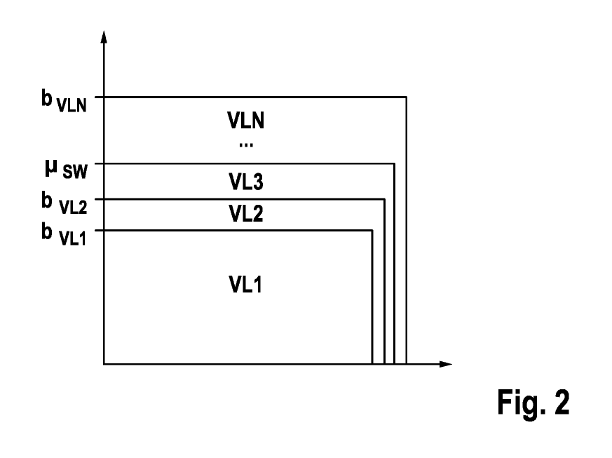

FIG. 3 shows an exemplary streaming scenario in an automotive setting;

FIG. 4a shows exemplary video levels of the prior art;

FIG. 4b shows exemplary video levels of the present invention; and

FIG. 5 shows a timing diagram for a network scenario.

### DETAILED DESCRIPTION OF THE DRAWINGS

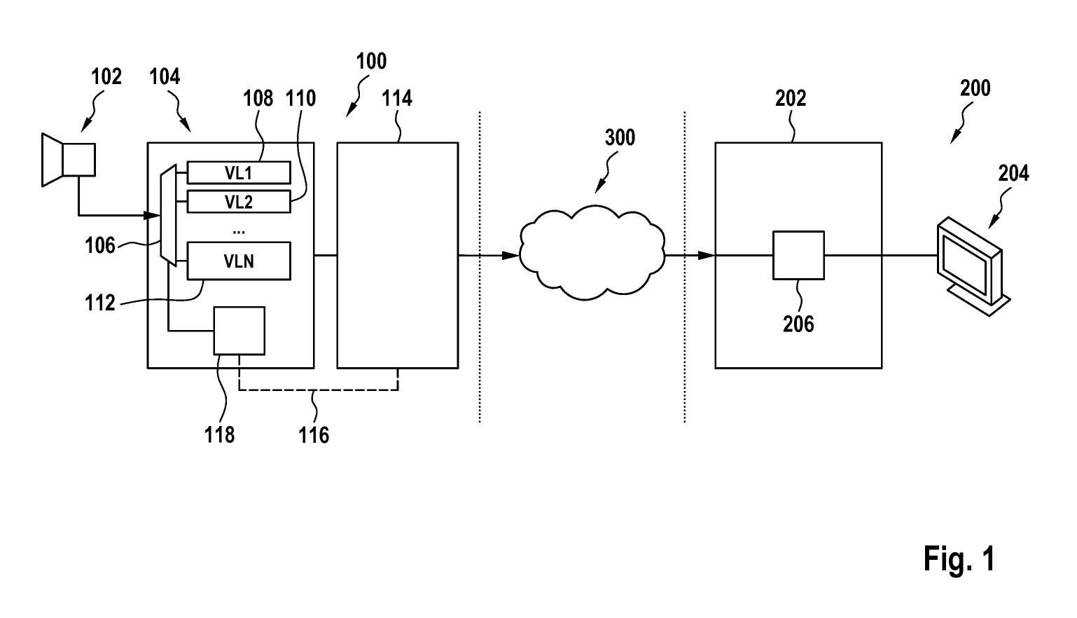

FIG. 1 shows an exemplary streaming architecture. A camera 102 produces image data that are transferred to a video compression apparatus 104. The video compression device 104 comprises a compression device 106 that compresses the video data stream received from the camera into a plurality of video data streams 108, 110, 112 using a different compression rate. The video compression apparatus 104 may be implemented on a mobile terminal by means of a piece of software, for example. The video data compression device 104 may also be implemented in a controller of a motor vehicle. The camera 102 may be the front camera of a motor vehicle.

The video compression apparatus 104 further comprises an ascertainment device 118 that is designed to use an interface 116 to receive a piece of information about a possible network performance level, i.e. possible network bandwidths. The radio access node 114 can also use the interface to transfer the mean network performance level μBW. The video compression apparatus 104 may be connected to the radio access node via a mobile radio network (not shown). The radio access node 114 sends the video data streams 108, 110, 112 via a network 300 to a streaming receiver 202 to which a display device 204 is connected.

As has been described above, the radio access node 114 (mobile phone) can use the interface 116 to transfer to the ascertainment device 118 the mean network performance level μBW between the radio access node and the video compression device 104. Further, the mean network performance level μBW can be determined by a measurement of the uplink network performance and/or by location-dependent historic network performance data. Subsequently, the compression device 106, which can have an AHS/DASHN encoder, produces the video streams 108, 110, 112, produced from a single video signal, which each have what is known as a video level VL1, VL2, VL3, VL4 associated with them. The video level can have a frame rate, a resolution and/or a bit rate. The compression of the N video streams 108, 110, 112 by means of the N video levels can be effected in a network performance range dependent on μBW

rε{μBW−δ_{lb}; μBW+δ_{ub}},

where δ_{ub} and δ_{lb} specify the network performance range around μBW,E2E.

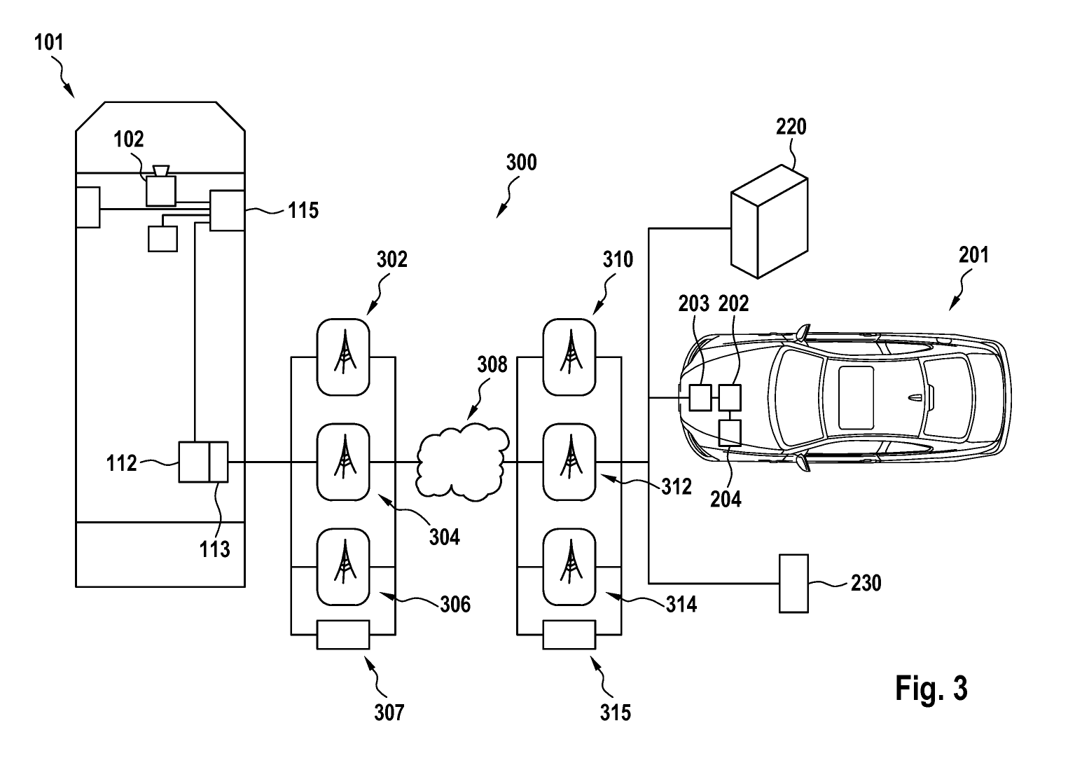

Exemplary video levels are shown in FIG. 3.

The AHS/DASH reception device 206 of the streaming receiver 202 of the prior art does not need to be adapted for this embodiment.

By taking into consideration the network context, i.e. the network performance level, the network bandwidth and the like, it is possible to produce video levels having small differences. The finely granular gradation of the video levels allows an improvement in subjective user quality to be achieved, because the streaming receiver 202 can select the video data stream 108, 110, 112 that produces the highest level of user satisfaction (QoE) for transmission.

In a further embodiment, a statistical means can be used to determine what compression is used to produce the video data streams 108, 110, 112. The ascertainment device 118 ascertains how frequently the respective video data stream 108, 110, 112 is retrieved by the streaming receivers 202. This allows efficiency to be increased if the streaming receivers request only some of the video data streams 108, 110, 112.

If there is a high probability of all streaming receivers 202 retrieving the video data stream 108 having the lowest bit rate VL1, then it can be assumed that many streaming receivers 202 have a network link with a low network performance level, for example UMTS. A similar case exists when many streaming receivers 202 have a network link with a high network performance level, for example LTE, and hence retrieve the video data stream 112 having the highest bit rate VLN. In order to attain an improvement in the level of user satisfaction for this user group, the inventors have proposed producing compression rates, for example video levels, with bit rates in a range around the network performance level, where it holds that:

rε{b_{VL.1}−δ_{lb}; b_{VL.1}+δ_{ub}};

where δ_{lb} and δ_{ub} prescribe the lower and upper ranges of the bit rates, which can be adapted in accordance with the updated request statistics of the video levels.

It is furthermore conceivable for the retrieval-statistic-based selection of the compression rates, for example video levels, also to be made for multiple groups having a very different network link by means of different network technologies at the same time. If there are two groups of streaming receivers 202, for example, with one group having a low network performance level (UMTS) and the other group having a high network performance level (LTE), then some of the video data streams 108, 110, 112 can be provided for a group of streaming receivers 202 having a high network performance level and some of the video data streams can be provided for a group of streaming receivers 202 having a low network performance level.

The invention can be used to achieve context-dependent and/or location-dependent adaptation of the compression, for example of the video levels, efficient use of the video data streams 108, 110, 112 and of the compression rates or video levels, and an improvement in the subjective level of user satisfaction. This advantage can be achieved essentially by the fine gradation of the video levels, since a user has a negative perception of large quality changes. The smaller the gradations between the video levels, the higher the subjective level of user satisfaction, this not being able to be achieved in comparison with coarsely granular gradations of the video levels or compression rates.

The fine gradations of the compression rate (for the third compression rate) can preferably be chosen such that it is slightly above the limit of perceptual distinguishability. Hence, the user is provided with a perceptible quality improvement for the selection of a higher video level using a lower compression rate, but without the difference being so great that the intensity of the image quality change alone has a disruptive influence on the level of user satisfaction again.

FIG. 3 shows an application of the present invention in an automotive environment. A motor vehicle 101 comprises a driver assistance camera 102 that is connected to the video compression device 112. A transmission device 113 sends the video data stream to a network 300. The network 300 can have a wide area network (WAN). The transmission device 113 may be coupled to the wide area network 308 by means of a GSM network, a UMTS network 304, an LTE network and a WLAN 307.

A second motor vehicle 201 is connected to the wide area network 308 by means of a receiver 203 via a GSM network, a UMTS network 302 and an LTE network 314. The receiver 203 receives the video data stream produced by the camera 102 via the network 300. The video data stream is decoded and decompressed by the streaming receiver 202 and presented on the display device 204.

The text below describes an exemplary application in the form of a live video data stream that is used to transmit a video from the driver assistance camera 102 of the first motor vehicle 101 to a system outside the first motor vehicle 101 (offboard system). In this case, it must be borne in mind that both the transmission device 113 and the reception device 203 have a different network performance level depending on the present location. The first motor vehicle comprises a central telematics device 115, which is also referred to as an automotive telecommunication module (ATM) and which can set up a communication by the transmission device 113 with the GSM network 302, the UMTS network 304, the LTE network 306 and the WLAN network. In one embodiment, the compression apparatus 112 can produce up to four video data streams 108, 110, 112 or video levels in parallel.

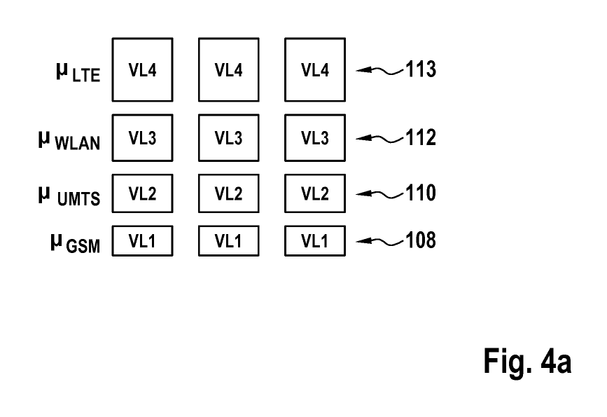

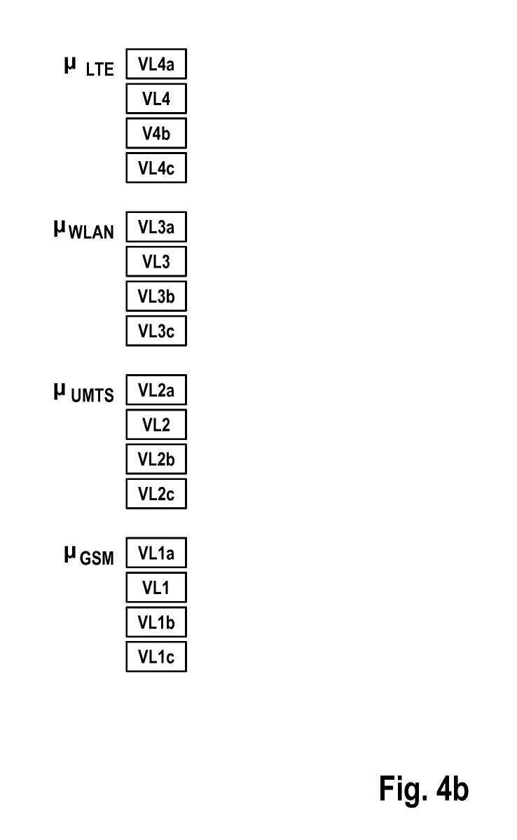

In an implementation of the prior art that uses fixed compression rates, it would be necessary to stipulate four compression rates at the implementation time that cover a network performance range from 110 kbit/s for a GSM network to 50 Mbit/s for an LTE network. For a resolution of 1170×600 pixels for the video data stream, suitable video levels would be 100 kbit/s (VL1), 1 Mbit/s (VL2), 3 Mbit/s (VL3) and 4 Mbit/s (VL4). Such video levels are depicted in FIG. 4, the vertical direction depicting the video levels and the horizontal direction depicting the video segments of the respective instance of the four video data streams 108, 110, 112, 113.

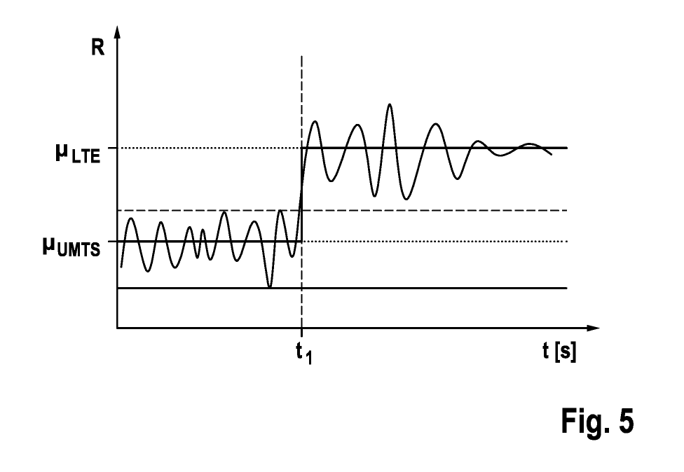

FIG. 5 shows network performance as a function of time when the first motor vehicle 1 is in an area having a changing network performance level. In the period up to t₁, the vehicle has a connection via the UMTS network 304 (VL2) and performs a handover to the LTE network 306 (VL4) at the time t₁. As a result of the use of the previously coarsely gradated video levels, the requested video levels are adapted not during the connection but rather only on a handover between the UMTS network 304 and the LTE network 306. In the prior art, a change of network technology leads to a large change in the bit rate of the video level, which may be 3 Mbit/s, in this example. Further, the implementation of the prior art is disadvantageous because there is the risk of a buffer underrun if the bandwidth of the network connection fluctuates.

According to the invention, one embodiment involves additional network-dependent video levels being provided that define a different compression rate or video level for each network technology. This can allow a finer gradation of the compression rates to be realized on the basis of network performance, which results in an improvement in the level of user satisfaction.

FIG. 4b depicts such video levels. In addition to the video level VL1, the video levels VL1a, VL1b and VL1c are provided, which each have a different compression and bandwidth. In addition to the video level VL2, the video levels VL2a, VL2b and VL2c are provided, having a different bit rate and/or compression rate. Further, in addition to the video level VL3, the video levels VL3a, VL3b and VL3c are provided, which differ from the video level VL3 in terms of compression rate and/or bit rate. Besides the video level VL4, the video levels VL4a, VL4b and VL4c are provided, which differ from the video level VL4 in terms of compression rate and/or bit rate. The difference between the original video levels VL1, VL2, VL3, VL4 and the additionally introduced video levels VL1a-VL1c, VL2a-VL2c, VL3a-VL3c, VL4a-VL4c is much smaller than the difference between the compression rates or video levels VL1, VL2, VL3 and VL4 that are associated with the respective network technologies. On account of the comparatively low performance level of a video compression device 106 implemented in a mobile device, only four video levels from the video levels described above are produced at the same time. In other words, the video compression device 106 produces only four of the video data streams having different video levels that are provided in FIG. 4b.

In a further embodiment, a video data stream needs to be provided for multiple users of a smartphone via the mobile radio network 310, 312, 314. In this embodiment, the performance of the coding unit, for example the video compression apparatus 206, of the source is limited and the video compression apparatus 206 can provide the video data stream from the camera 102 using only four video data streams. The two video levels having the lowest video quality are produced by reducing the spatial resolution of the video. In this embodiment, the video level VL1 can support a resolution of 585×300 pixels and a bit rate of 100 kbit/s, the video level VL2 can support a resolution of 585×300 pixels and a bit rate of 1 Mbit/s, the video level VL3 can support a resolution of 1170×600 pixels and a bit rate of 3 Mbit/s and the video level VL4 can support a resolution of 1170×600 pixels and a bit rate of 5 Mbit/s. In this embodiment, two smartphones request the video at the same time. The first smartphone has a native screen resolution of 600×400 pixels. The video reproduction device of said smartphone cannot support a resolution of 1170×600 pixels, and therefore this smartphone retrieves only the video levels VL1 and VL2 from the video compression device 112. The second smartphone S2 has a permanently poor radio link, for example on account of its present position in a building, and therefore the present bandwidth is limited to 4 Mbit/s. The smartphone S2 retrieves only the video levels VL1, VL2 and VL3 from the compression apparatus.

After a predetermined period, the video level VL4 has never been retrieved from the video compression device 106. Consequently, the video compression device may be designed to no longer provide the video level VL4 and to provide the video level VL2′, having a resolution of 585×300 pixels and a bit rate of 2 Mbit/s, as a new video level, which can improve the level of user satisfaction for the user as a result of finer gradation of the video levels.

The compression apparatus 206 is relieved of load according to the invention, since depending on the situation, depending on the location, depending on the load and/or depending on the context, only a limited number of compressed data streams are provided using the requisite compression, for example video levels. Further, the invention increases the level of user satisfaction, since, if a compressed data stream is called frequently, an additional data stream can be produced using a similar compression rate, as a result of which the compression rates can be gradated in finer stages.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for compressing a data stream from a source to at least one sink, the method comprising the steps of:
ascertaining a first bandwidth and a second bandwidth of a network that are available to the source for transmitting the data stream to the at least one sink;
compressing the data stream using at least a first compression rate to produce a first compressed data stream and using a second compression rate to produce a second compressed data stream, wherein the first compression rate is optimized for transmission at the first bandwidth and the second compression rate is optimized for transmission at the second bandwidth; and
providing the first compressed data stream and the second compressed data stream for transmission at the same time.

2. The method as claimed in claim 1, wherein ascertaining the first bandwidth and the second bandwidth further comprises ascertaining statistical data relating to data streams requested from the source.

3. The method as claimed in claim 1, wherein ascertaining the first bandwidth and the second bandwidth further comprises at least one of:
ascertaining a bandwidth from the network to the at least one sink based on statistical data that includes compression rates used by the at least one sink to request the first and second compressed data streams; and
ascertaining a distribution of the bandwidth from the network to a plurality of sinks based on access to the first and second compressed data streams in a present period, wherein the distribution comprises compression rates are used by the plurality of sinks to request the compressed data streams.

4. The method as claimed in claim 2, wherein ascertaining the first bandwidth and the second bandwidth further comprises at least one of:
ascertaining a bandwidth from the network to the at least one sink based on statistical data that includes compression rates used by the at least one sink to request the first and second compressed data streams; and
ascertaining a distribution of the bandwidth from the network to a plurality of sinks based on access to the first and second compressed data streams in a present period, wherein the distribution comprises compression rates are used by the plurality of sinks to request the compressed data streams.

5. The method as claimed in claim 1, wherein ascertaining the first bandwidth and the second bandwidth further comprises at least one of:
ascertaining a bandwidth from the source to the network;
ascertaining the bandwidth from the network to the at least one sink;
measuring a present bandwidth from the source to the network;
measuring the present bandwidth from the network to the sink;
ascertaining a probable bandwidth from the source to the network using historic data;
ascertaining the probable bandwidth from the network to the sink using historic data;
ascertaining a behavior of a plurality of sinks;
ascertaining the bandwidth from the network to the at least one sink using statistical data;
ascertaining a distribution of the bandwidth from the network to the plurality of sinks based on access to the first and second compressed data streams in a present period; and
requesting possible bandwidths from the network.

6. The method as claimed in claim 1, further comprising the acts of:
ascertaining a property of an application of the at least one sink; and
determining at least one of the first compression rate and the second compression rate based on the property of the application of the at least one sink.

7. The method as claimed in claim 1, further comprising the acts of:
compressing the data stream using a third compression rate, for which at least one parameter is modified in comparison with the first compression rate, the difference between the third compression rate and the first compression rate being less than or equal to the difference between the third compression rate and the second compression rate; and
terminating compression of the data stream using the second compression rate.

8. The method as claimed in claim 7, wherein
the property of the application of the at least one sink is a resolution,
the third compression rate has the same resolution as the first compression rate, and
the third compression rate has a different frame rate than the first compression rate.

9. The method as claimed in claim 1, wherein at least one of the data stream and the first and second compressed data streams have video data, wherein a compression rate for the video data comprises at least one of a frame rate, an image quality and a resolution.

10. The method as claimed in claim 2, wherein at least one of the data stream and the first and second compressed data streams have video data, wherein a compression rate for the video data comprises at least one of a frame rate, an image quality and a resolution.

11. The method as claimed in claim 3, wherein at least one of the data stream and the first and second compressed data streams have video data, wherein a compression rate for the video data comprises at least one of a frame rate, an image quality and a resolution.

12. The method as claimed in claim 1, wherein the source is a mobile device and the network is a mobile radio network, and wherein at least one of a bandwidth and a mobile radio technology of the mobile radio network vary based on a location of the source.

13. A compression apparatus configured to compress a data stream, the apparatus comprising:
an ascertainment device configured to ascertain at least a first bandwidth and a second bandwidth of a network that are available to a source transmitting the data stream to at least one sink; and
a compression device configured to compress the data stream using at least a first compression rate to produce a first compressed data stream and to compress the data stream using a second compression rate to produce a second compressed data stream, wherein the first compression rate is optimized for transmission using the first bandwidth and the second compression rate is optimized for transmission using the second bandwidth,
wherein the source is a mobile device that provides the first compressed data stream and the second compressed data stream for transmission at the same time, and the network is a mobile radio network,
wherein at least one of a bandwidth and mobile radio technology of the mobile radio network vary based on a location of the source.

14. The compression apparatus as claimed in claim 13, wherein the ascertainment device is configured to at least one of:
ascertain a bandwidth from the source to the network,
ascertain the bandwidth from the network to the at least one sink,
ascertain a present bandwidth from the source to the network,
ascertain the present bandwidth from the network to the at least one sink,
ascertain a probable bandwidth from the source to the network using historic data,
ascertain the probable bandwidth from the network to the at least one sink using historic data,
ascertain a behavior of a plurality of sinks,
ascertain the bandwidth from the network to the at least one sink using statistical data, and
retrieve from the network a piece of information about available bandwidths.

15. The compression apparatus as claimed in claim 13, wherein the ascertainment device is further configured to ascertain the bandwidth from the network to the at least one sink using statistical data that includes compression rates used by the plurality of sinks to request the first and second compressed data streams.

16. The compression apparatus as claimed in claim 13, wherein the ascertainment device is further configured to ascertain the distribution of the bandwidth from the network to the plurality of sinks based on access to the first and second compressed data streams in a present period, wherein the distribution comprises compression rates used by the plurality of sinks to request the first and second compressed data streams.

17. A video compression apparatus, having a compression apparatus as claimed in claim 13, wherein at least one of the data stream and the first and second compressed data streams have video data, and wherein a compression rate for the video data comprises at least one of a frame rate, an image quality and a resolution.
